(19) United States
(12) Patent Application Publication
(10) Pub. No.: US 2026/0032095 A1
(43) Pub. Date: Jan. 29, 2026

(54) IN-HOME COMMUNICATION DEVICE AND FILTERING METHOD

(71) Applicant: Mitsubishi Electric Corporation, Chiyoda-ku, Tokyo (JP)

(72) Inventor: Masahide NISHIKAWA, Tokyo (JP)

(21) Appl. No.: 18/854,865

(22) PCT Filed: Apr. 27, 2022
(86) PCT No.: PCT/JP2022/019112

§ 371 Date: Oct. 9, 2025

(51) Int. Cl. H04L 51/212; H04L 61/103

(52) U.S. Cl. CPC H04L 51/212; H04L 61/103

(57) ABSTRACT

An HGW (110) includes a WAN I/F unit (112) that receives a packet; and an IPv6 packet filter function unit (125) that performs address resolution and routing of the packet and executes MAC filtering, which is a filtering of the destination MAC address of the packets after the routing, according to a rule of an IP packet filter.

### TECHNICAL FIELD

This disclosure relates to in-home communication devices and filtering methods.

### BACKGROUND ART

Due to the problem of IP address exhaustion in IPv4 (Internet Protocol version 4), IPv6 has been used in recent years.

With IPv6, it is difficult to perform the filtering determination by specifying the IP (Internet Protocol) address of the terminal accommodated by the in-home communication device, which has been commonly performed as a packet filtering process with the conventional IPv4 in in-home communication device.

The main reasons for this are (a) and (b) below.
(a) IPv6 address to be assigned to a terminal on the LAN (Local Area Network) side is formed by redistributing part of the global IPv6 (Internet Protocol version 6) address prefix distributed by a communication network provider in IPv6 prefix Delegation operation. Therefore, the Prefix part of an IPv6 address of the terminal on the LAN side depends on the address distributed by the communication network provider, so that the Prefix part of the IPv6 address cannot be freely decided in advance. In addition, the subnet length of the Prefix part is also specified by the network operator, so that the subnet length of the Suffix part of the terminal on the LAN side also depends on the subnet length of that Prefix part.
(b) In IPv6, it is common for a LAN-side terminal to belong to multiple networks and to perform an address setting operation that generates a terminal address with multiple prefixes distributed from each network, such as MultiHoming.

Due to the above, packet filtering by IPv6 addressing cannot be performed unless the address distributed by the communication network provider and redistributed to the LAN-side terminal by the IPv6 Prefix Delegation operation is confirmed. Furthermore, in IPv6 MultiHoming operation or the like, if a terminal connects to a new IPv6 network after a packet filter is configured and then a new prefix is distributed, the packet filter will not follow the new address.

In this regard, filtering does not necessarily require an IP address to be specified, but one possible method is to specify the target terminal by the MAC (Media Access Control) address of the LAN-side terminal that is known to the in-home communication device. Specifying the terminal by MAC address solves the above problem caused by the difficulty in specifying IPv6 addresses in advance.

Here, for example, if the in-home communication device uses Linux as its OS (Operating System), the filter mechanism called iptables provided in Linux is used as a packet filter. The iptables of Linux provide a filtering specification by source MAC address.

Therefore, when transmitting packets in the direction from a LAN to a WAN (Wide Area Network), this function can be used to specify the source MAC address to filter packets received from terminals on the LAN side.

In this regard, Patent Document 1 discloses a method of configuring a load balancer as an example configuration that uses filtering by MAC address and iptables.

### PRIOR ART REFERENCE

### Patent Reference Patent Document 1: JP 2019-176323 A

### SUMMARY OF INVENTION

### Problem to be Solved by the Invention

However, when packets are received from the WAN side to the LAN side, it is not easy to filter the destination terminal on the LAN side by MAC address. The reason for this is that in order to perform filtering using MAC addresses, the in-home communication device needs to go through the following steps 1 through 3.
Step 1: The in-home communication device determines the destination I/F (InterFace) for the destination IP address by routing the packet in the direction from the WAN side to the LAN side.
Step 2: The in-home communication device finds out the destination MAC address corresponding to the destination IP address at the determined destination I/F. Here, if necessary, the in-home communication device needs to perform IPv4 ARP (Address Resolution Protocol) resolution or IPv6 neighbor resolution and hold the packet during the resolution.
Step 3: The in-home communication device performs filtering by this destination MAC address.

However, current iptables do not have the above filtering mechanism. The main reasons for this are considered to be the following (c) through (e).
(c) The destination MAC address is only required when the destination I/F is an I/F that communicates with a Layer 2 address, such as Ethernet I/F, and is not required when the destination I/F is an I/F that does not require a Layer 2 address, such as PPP I/F (Point-to-Point Protocol I/F).
(d) It is not appropriate to process the case where the destination I/F requires a Layer 2 address by Layer processing such as IP packet filtering.
(e) For this reason, Layer 3 processing is configured to perform only common processing that does not depend on the Layer 2 type of the destination I/F, and the destination MAC address resolution required for Layer 2 transmission is performed at the final stage of transmission from the destination I/F, requiring a scalable and flexible IP stack structure while maintaining the hierarchical structure of the communication layers.

On the other hand, due to the processing order of steps 1 to 3 above, at the Layer 3 IP packet filter stage to be performed first, the destination MAC address to be resolved later is still unresolved, and therefore the destination MAC address for the LAN-side terminal cannot be specified.

Thus, although the in-home communication device has the advantage of being able to designate LAN-side terminals prefix independent of the IPv6 distributed by the communication network by designating LAN-side IPv6 terminals with the MAC address, there arises a problem in implementing a filter in which LAN-side terminals are specified by using destination MAC addresses when receiving packets in the direction from the WAN side to the LAN side, so that filtering of LAN-side terminals independent of the IPv6 prefix distributed from the communication network has not been implemented.

Therefore, an object of one or more of the aspects of the present disclosure is to implement filtering for LAN-side terminal communication without depending on the IPv6 prefix distributed from the communication network.

### Means of Solving the Problem

An in-home communication device according to an aspect of the present disclosure includes: a reception interface that receives a packet; a forwarding unit that performs address resolution for the packet and routes the packet; and an extension function unit that performs MAC filtering, which is a filtering of the destination MAC (Media Access Control) address of the packet after the routing, according to a rule of an IP (Internet Protocol) packet filter.

A filtering method according to an aspect of the present disclosure includes: receiving a packet; routing the packet; resolving the address of the packet after the routing according to a rule of an IP (Internet Protocol) packet filter; and performing MAC filtering, which is a filtering of the destination MAC (Media Access Control) address of the packet resolved by the address resolution.

### Effects of the Invention

According to one or more aspects of the present disclosure, filtering can be implemented for communications of terminals on the LAN side without relying on IPv6 prefixes distributed from the communication network.

### BRIEF DESCRIPTION OF DRAWINGS

FIG. 1 is a block diagram schematically illustrating a configuration of a communication system including HGWs, which are in-home communication devices according to Embodiments 1 to 3.

FIG. 2 is a block diagram schematically illustrating a configuration of an IPv6 packet filter function unit in Embodiment 1.

FIG. 3 is a schematic diagram illustrating an example of a LAN-side filtering setting screen image.

FIG. 4 is a schematic diagram illustrating an example of an entry input screen image for entering one entry for a LAN-side filter.

FIG. 5 is a schematic diagram illustrating an example of a WAN-side filtering setting screen image.

FIG. 6 is a schematic diagram illustrating an example of an entry input screen image for entering one entry for a WAN-side filter.

FIGS. 7A and 7B are block diagrams illustrating an example hardware configuration.

FIG. 8 is a flowchart schematically illustrating a packet filter operation inside Linux.

FIG. 9 is a schematic diagram illustrating a first deployment example of the packet filter operation inside Linux.

FIG. 10 is a schematic diagram illustrating a second deployment example of the packet filter operation inside Linux.

FIG. 11 is a simplified block diagram illustrating an IP packet filter process and a destination MAC resolution process in Embodiment 1.

FIG. 12 is a flowchart illustrating a DSTMAC target process.

FIG. 13 is a block diagram schematically illustrating an example implementation of a queuing process of the DSTMAC target.

FIG. 14 is a flowchart illustrating a process performed by a routed-dst-mac processing unit.

FIG. 15 is a block diagram schematically illustrating an IPv6 packet filter function unit in Embodiment 2.

FIG. 16 is a schematic diagram illustrating a third deployment example of the packet filter operation inside Linux.

FIG. 17 is a simplified block diagram illustrating an IP packet filter process and a destination MAC resolution process in Embodiment 2.

FIG. 18 is a flowchart illustrating an operation of the DSTMAC processing unit when a packet under destination MAC resolution is held by NFQUEUE in Embodiment 2.

FIG. 19 is a block diagram schematically illustrating a configuration of an IPv6 filter function unit in Embodiment 3.

### MODE FOR CARRYING OUT THE INVENTION

### EMBODIMENT 1

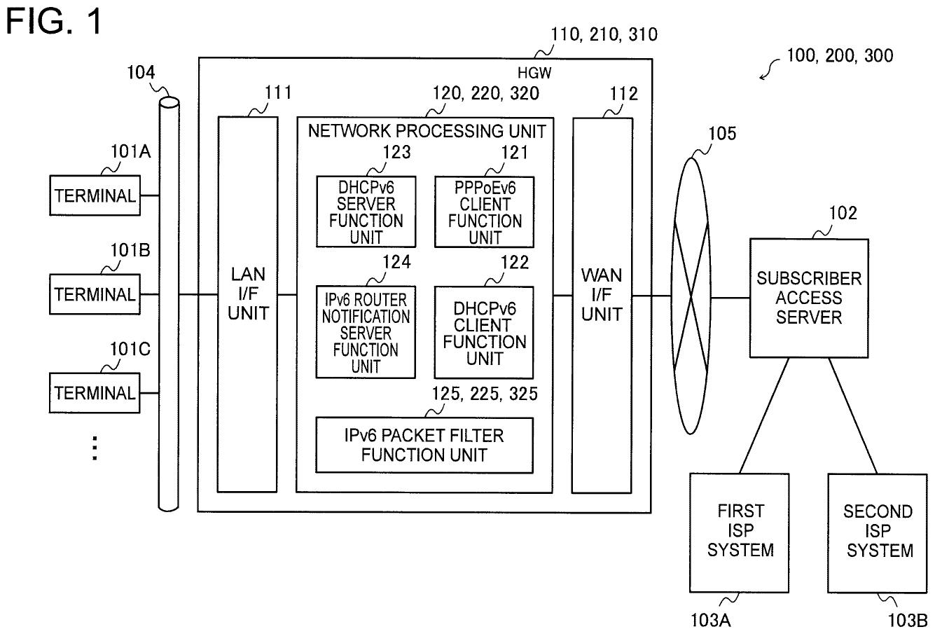

FIG. 1 is a block diagram schematically illustrating a configuration of a communication system 100 including an HGW (Home Gateway) 110, which is an in-home communication device according to Embodiment 1.

The communication system 100 includes a plurality of terminals 101A, 101B, 101C, . . . , a subscriber access server 102, a first ISP (Internet Service Provider) system 103A, a second ISP system 103B, and an HGW 110.

Each of the plurality of terminals 101A, 101B, 101C, . . . is referred to as a terminal 101 when there is no need to distinguish each of the terminals 101A, 101B, 101C, . . . in particular.

The terminal 101 and the HGW 110 are connected to the LAN 104, and the HGW 110 and the subscriber access server 102 are connected to a subscriber communication network 105 such as the Internet.

The terminal 101 accesses the subscriber communication network 105 via the HGW 110. The subscriber access server 102 is a server that the terminal 101 accesses in order to access the subscriber communication network 105.

The first ISP system 103A is a system of a provider providing the first Internet service, and the second ISP system 103B is a system of a provider providing the second Internet service. Here, the first Internet service is different from the second Internet service.

The HGW 110 is equipped with a LAN I/F unit 111, a WAN I/F unit 112, and a network processing unit 120. The LAN I/F unit 111 is a LAN-side communication interface for communication via the LAN 104.

The WAN I/F unit 112 is a WAN-side communication interface for communication via the subscriber communication network 105 as a WAN.

Here, the LAN I/F unit 111 or the WAN I/F unit 112 functions as a reception I/F to receive packets, and the LAN I/F unit 111 or the WAN I/F unit 112 also functions as a transmission I/F to transmit packets.

The network processing unit 120 controls processing in the HGW 110. For example, the network processing unit 120 controls the relay processing that outputs packets from the subscriber communication network 105 to the LAN 104 and packets from the LAN 104 to the subscriber communication network 105. Here, it is assumed that the network processing unit 120 supports IPv6.

The network processing unit 120 includes a PPPoEv6 client function unit 121, a DHCPv6 client function unit 122, a DHCPv6 server function unit 123, an IPv6 router notification server function unit 124, and an IPv6 packet filter function unit 125.

The PPPoEv6 client function unit 121 uses PPPoE (Point-to-Point Protocol over Ethernet), which is an IPv6 Internet connection service, via the WAN I/F unit 112 to perform communication through the subscriber communication network 105.

The DHCPv6 client function unit 122 obtains an IPv6 IP address from a DHCP (Dynamic Host Configuration Protocol) server (not shown) included in the first ISP system 103A or the second ISP system 103B via the WAN I/F unit 112.

The DHCPv6 server function unit 123 functions as an IP address distribution unit that distributes IP addresses to the terminal 101.

For example, the DHCPv6 server function unit 123 distributes IPv6 IP address information to the terminal 101 via the LAN I/F unit 111. Specifically, the DHCPv6 server function unit 123 distributes, to the terminal 101, IP addresses included in the IPv6 address range according to the IPv6 prefix obtained from the first ISP system 103A or the second ISP system 103B connected to the subscriber communication network 105.

The IPv6 router notification server function unit 124 automatically configures IPv6 IP addresses via the LAN I/F unit 111.

For example, the IPv6 router notification server function unit 124 functions as an IP address notification unit that causes the terminal 101 to generate an IP address by notifying the terminal 101 of an IPv6 address range according to the IPv6 prefix obtained from the first ISP system 103A or the second ISP system 103B connected to the subscriber communication network 105.

The IPv6 packet filter function unit 125 controls and performs filtering of packets received by the LAN I/F unit 111 from the LAN 104 side and packets received by the WAN I/F unit 112 from the subscriber communication network 105 side.

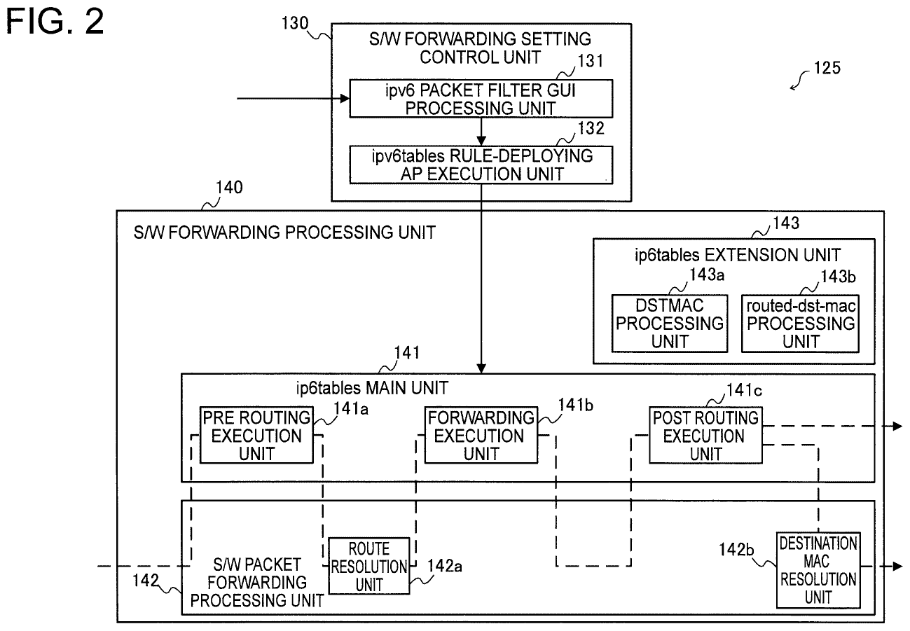

FIG. 2 is a block diagram schematically illustrating the IPv6 packet filter function unit 125.

As shown in the figure, the IPv6 packet filter function unit 125 includes an S/W (SoftWare) forwarding setting control unit 130 and an S/W forwarding processing unit 140.

The S/W forwarding setting control unit 130 causes the S/W forwarding processing unit 140 to perform filtering with methods such as to perform GUI setting from any of the terminals 101 via LAN I/F unit 111 or to read configuration settings from information processing devices such as other computers (not shown), or according to LAN-side filtering settings or WAN-side filtering settings obtained from an information processing device such as another computer via a connection such as USB (Universal Serial Bus) (not shown in the figure). Here, the LAN-side filtering settings are the settings for filtering packets from the LAN 104 side, and the WAN-side filtering settings are the settings for filtering packets from the WAN side, i.e., the subscriber communication network 105 side.

The S/W forwarding setting control unit 130 includes an ipv6 packet filter GUI (Graphical User Interface) processing unit 131 and an ipv6tables rule-deploying AP (application) execution unit 132.

The ipv6 packet filter GUI processing unit 131 causes the terminal 101 or information processing equipment (not shown) described above to display a screen image of the GUI for LAN-side filtering settings or WAN-side filtering settings and to accept the input of LAN-side filtering settings or WAN-side filtering settings through the screen image from the operator, thereby obtaining such settings.

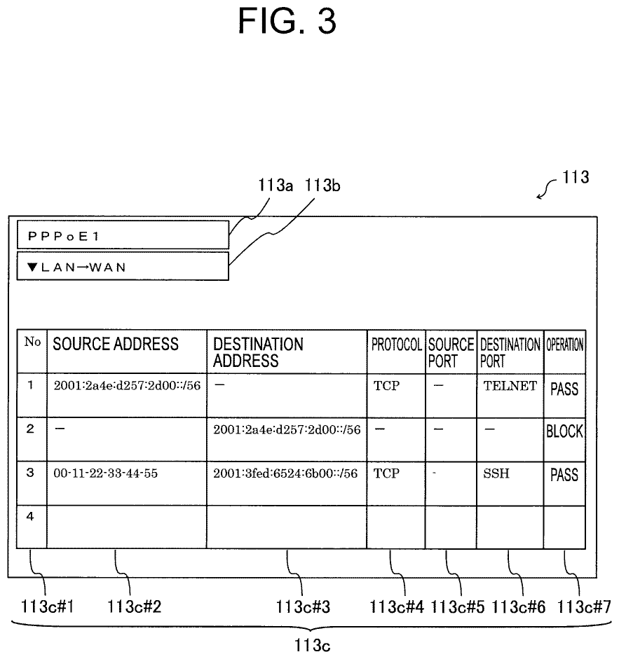

FIG. 3 is a schematic diagram illustrating an example of a LAN-side filtering setting screen image.

As shown in FIG. 3, the LAN-side filtering setting screen image 113 includes a packet filter target I/F selection area 113a, a packet filter direction selection area 113b, and a packet filter entry list display area 113c.

As shown in the packet filter target I/F selection area 113a and packet filter direction selection area 113b, the LAN-side filtering setting screen image 113 shown in FIG. 2 is a screen image for setting up a connection that starts in the direction from the LAN 104, which communicates with “PPPoE1”, to the subscriber communication network 105, which is the WAN.

The entry list display area 113c is an area for setting filters for packets to be forwarded in the direction from the LAN 104 to the subscriber communication network 105. The entry list display area 113c displays the filter settings entered by the operator, as described below. One entry corresponding to one row in the entry list display area 113c indicates one filter.

For example, the entry list display area 113c includes an entry number column 113c#1, a source address display column 113c#2, a destination address display column 113c#3, a protocol type display column 113c#4, a source port number display column 113c#5, a destination port number display column 113c#6, and an entry operation display column 113c#7.

The entry number column 113c#1 displays the entry number as identification information to identify the entry.

The source address display column 113c#2 displays the specified address when the source address is specified as a filter on the LAN 104 side.

The destination address display column 113c#3 displays the specified address when the destination address is specified as the filter on the LAN 104 side.

The protocol type display column 113c#4 displays the specified protocol when the protocol is specified as a filter on the LAN 104 side.

The source port number display column 113c#5 displays the specified port when the source port is specified as a filter on the LAN 104 side.

The destination port number display column 113c#6 displays the specified port when the destination port is specified as a filter on the LAN 104 side.

The entry operation display column 113c#7 displays the operation as a filter on the LAN 104 side.

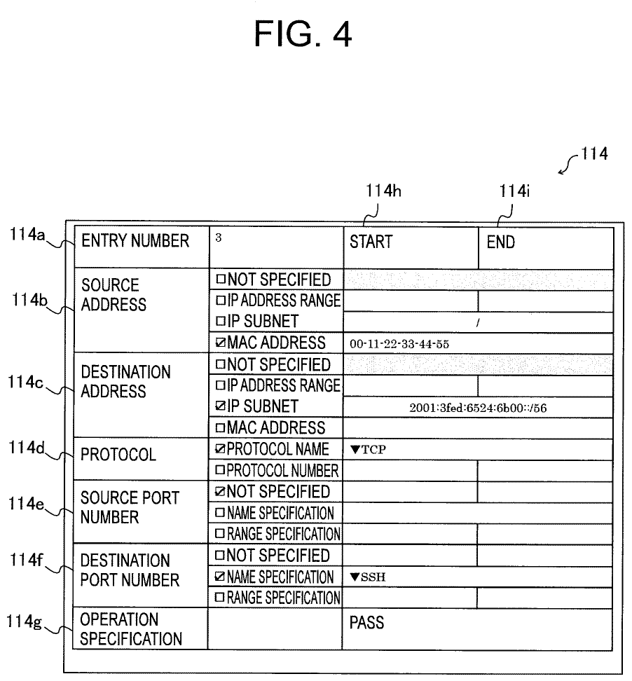

FIG. 4 is a schematic diagram illustrating an example of an entry input screen image for inputting one entry for a LAN-side filter.

The entry input screen image 114 shown in FIG. 4 is the screen image displayed when the entry of the entry number “3” is entered in FIG. 3.

The entry input screen image 114 includes a title field 114a, a source address specification field 114b, a destination address specification field 114c, a protocol specification field 114d, a source port number specification field 114e, a destination port number specification field 114f, and an operation specification field 114g.

In addition, there is provided a start value input column 114h and an end value input column 114i which are the fields for specifying a range in the source address specification field 114b, the destination address specification field 114c, the source port number specification field 114e, or the destination port number specification field 114f.

Here, the source address specification field 114b allows the user to specify the filtering target to be filtered by the source address from the “IP address range”, “IP subnet”, and “MAC address”, and the source MAC address is specified in this example.

Similarly, the destination address specification field 114c allows the user to specify the filtering target to be filtered by the destination address from the “IP address range”, “IP subnet”, and “MAC address”, and the IP subnet is specified in this example.

Items such as protocol, source port number, or destination port number can also be specified in the packet filter, but since these items are generally specified and not related to this embodiment, the explanation of these items is omitted.

Finally, in the operation specification field 114g, either “pass” or “block” is selectable, and “pass” is selected in this example.

By making the input as shown in FIG. 4, the filter for entry number “3” in FIG. 3 is set.

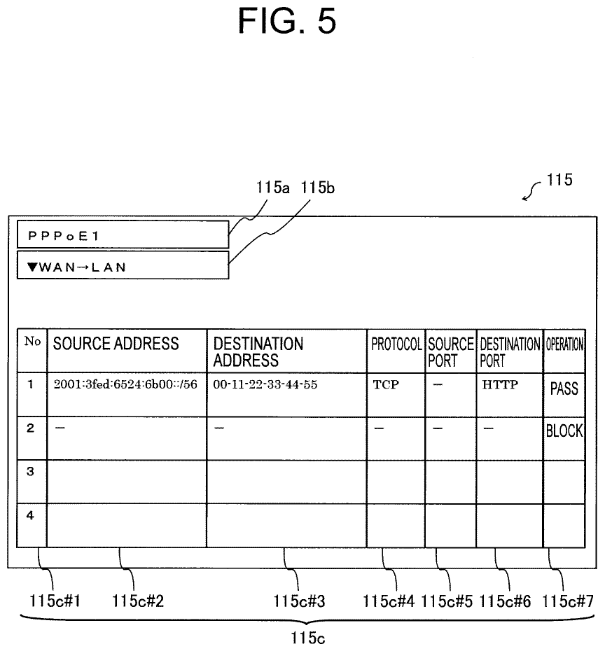

FIG. 5 is a schematic diagram illustrating an example of a WAN-side filtering setting screen image.

As shown in FIG. 5, the WAN-side filtering setting screen image 115 includes a packet filter target I/F selection area 115a, a packet filter direction selection area 115b, and a packet filter entry list display area 115c.

As shown in the packet filter target I/F selection area 115a and the packet filter direction selection area 115b, the WAN-side filtering setting screen image 115 shown in FIG. 5 is a screen image for setting up a connection that starts in the direction from the subscriber communication network 105, which is the WAN communicating with “PPPoE1”, to the LAN 104.

The entry list display area 115c is an area for setting filters for packets to be forwarded in the direction from the subscriber communication network 105 to the LAN 104. The entry list display area 115c is an area for displaying the filter settings entered by the operator, as described below. One entry corresponding to one row of the entry list display area 115c indicates one filter.

For example, the entry list display area 115c includes an entry number column 115c#1, a source address display column 115c#2, a destination address display column 115c#3, a protocol type display column 115c#4, a source port number display column 115c#5, a destination port number display column 115c#6, an entry operation display column 115c#7.

The entry number column 115c#1 displays the entry number as identification information to identify the entry. The source address display column 115c#2 displays the specified address when the source address is specified as a filter on the subscriber communication network 105 side.

The destination address display column 115c#3 displays the specified address when the destination address is specified as a filter on the subscriber communication network 105 side.

The protocol type display column 115c#4 displays the specified protocol when the protocol is specified as a filter on the subscriber communication network 105 side.

The source port number display column 115c#5 displays the specified port when the source port is specified as a filter on the subscriber communication network 105 side.

The destination port number display column 115c#6 displays the specified port when the destination port is specified as a filter on the subscriber communication network 105 side.

Entry operation display column 115C#7 displays the operation as a filter on the subscriber communication network 105 side.

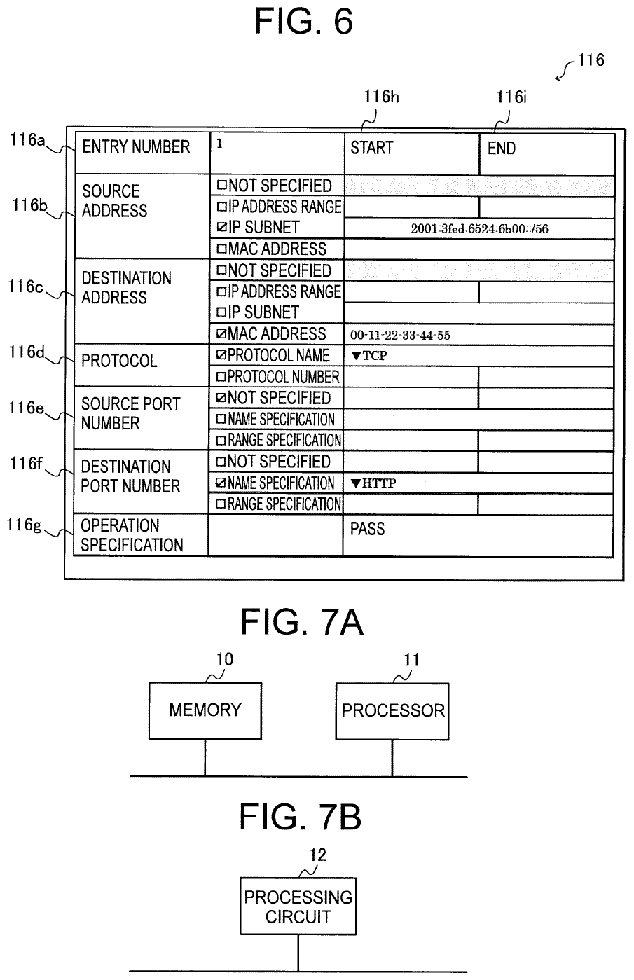

FIG. 6 is a schematic diagram illustrating an example of an entry input screen image for inputting one entry for a WAN-side filter.

The entry input screen image 116 shown in FIG. 6 is the screen image displayed when the entry number “1” is entered in FIG. 5.

The entry input screen image 116 includes a title field 116a, a source address specification field 116b, a destination address specification field 116c, a protocol specification field 116d, a source port number specification field 116e, a destination port number specification field 116f, and an operation specification field 116g.

In addition, there is provided a start value input column 116h and an end value input column 116i which are fields for specifying a range in the source address specification field 116b, the destination address specification field 116c, the source port number field specification 116e, or the destination port number specification field 116f.

Here, the source address specification field 116b allows the user to specify the filtering target to be filtered by the source address from the “IP address range”, “IP subnet”, and “MAC address”, and the IP subnet is specified in this example.

Similarly, the destination address specification field 116c allows the user to specify the filtering target to be filtered by the destination address from the “IP address range”, “IP subnet”, and “MAC address”, and the MAC address is specified in this example.

Items such as protocol, source port number, or destination port number can also be specified in the packet filter, but since these items are generally specified and not related to this embodiment, the explanation of these items is omitted.

Finally, in the operation specification field 116g, either “pass” or “block” is selectable, and “pass” is selected in this example.

By making the input as shown in FIG. 6, the filter for entry number “1” in FIG. 5 is set.

Returning to FIG. 2, the ipv6tables rule-deploying AP execution unit 132 sets the LAN-side filtering settings or the WAN-side filtering settings received by the ipv6 packet filter GUI processing unit 131 in the ip6tables main unit 141 described below in the S/W forwarding processing unit 140 and causes the S/W forwarding processing unit 140 to perform filtering according to the filtering settings.

The S/W forwarding processing unit 140 performs filtering of LAN-side packets received by the LAN I/F unit 111 or WAN-side packets received by the WAN I/F unit 112 and forwards those packets.

The S/W forwarding processing unit 140 includes an ip6tables main unit 141, an S/W packet forwarding processing unit 142, and an ip6tables extension unit 143.

The ip6tables main unit 141 sets up, manages, and inspects the IPv6 packet filter rule table in the Linux kernel, and performs filtering using the table.

The ip6tables main unit 141 includes a pre routing execution unit 141a, a forwarding execution unit 141b, and a post routing execution unit 141c. The processing of these functional units is the packet filter processing normally done in Linux and is described in detail in the following document, for example, so it will not be explained here.

Document: Iptables Tutorial 1.2.2 (retrieved on Dec. 16, 2021), URL: <https://www.frozenux.net/iptables-tutorial/iptables-tutorial.html>

When an IP address is specified in the source address display column 113c#2 or the destination address display column 113c#3 in the LAN-side filtering setting screen image 113 shown in FIG. 3, or when an IP address is specified in the source address display column 115c#2 or the destination address display column 115c#3 in the WAN-side filtering setting screen image 115 shown in FIG. 5, the ip6tables main unit 141 functions as a filtering execution unit that executes IP filtering, which is a filtering process using the IP address.

The S/W packet forwarding processing unit 142 executes the forwarding of LAN-side packets received by the LAN I/F unit 111 or WAN-side packets received by the WAN I/F unit 112.

The S/W packet forwarding processing unit 142 includes a route resolution unit 142a and a destination MAC resolution unit 142b. Since the processing in these functional units is also the packet forwarding processing normally performed inside Linux, a detailed explanation is omitted.

The ip6tables main unit 141 and the S/W packet forwarding processing unit 142 described above constitute the forwarding unit that performs address resolution for packets and routing of those packets.

The ip6tables extension unit 143 functions as an extension function unit that executes MAC filtering, which is a filtering of the destination MAC address of packets after routing by the ip6tables main unit 141 and the S/W packet forwarding processing unit 142 according to the IP packet filter rules.

The rule here is to perform address resolution of packets after routing and to perform MAC filtering by the destination MAC address resolved by the address resolution. Therefore, the ip6tables extension unit 143 causes the destination MAC resolution unit 142b to perform address resolution according to this rule and performs MAC filtering by the resolved MAC address.

In particular, in Embodiment 1, the WAN I/F unit 112 as the reception I/F receives a packet from the subscriber communication network 105, the ip6tables main unit 141 and the S/W packet forwarding processing unit 142 route the packet to the LAN 104, and the ip6tables extension unit 143 can perform MAC filtering on the destination MAC address that specifies the MAC address of the terminal 101 without using the IP address of the terminal 101 connected to the LAN 104.

For example, the ip6tables extension unit 143 performs filtering by a destination MAC address with the destination MAC resolution determination chain PPOE1_WAN_TO_LAN_rule1, which is an extension of the process in the ip6tables main unit 141, in response to instructions from the ip6tables main unit 141. The ip6tables extension unit 143 includes a DSTMAC processing unit 143a and a routed-dst-mac processing unit 143b.

The DSTMAC processing unit 143a is activated to perform the process of resolving the destination MAC address from the destination IP address, and provides received packets to the routed-dst-mac processing unit 143b according to the evaluation rules configured to allow packets to be subjected to destination MAC filtering to pass through the DSTMAC target.

The routed-dst-mac processing unit 143b performs a match determination between the destination MAC address of the packet from the DSTMAC processing unit 143a and the destination MAC address resolved from the destination IP address.

There are other existing extension operations for iptables as shown in the following document.

Document: Netfilter Extensions HOWTO (retrieved on Dec. 16, 2021), URL: <https://www.netfilter.org/documentation/HOWTO/netfilter-extensions-HOWTO.html>

For example, as shown in FIG. 7A, part or all of the network processing unit 120 described above may configured with a memory 10 and a processor 11, such as a central processing unit (CPU), that executes a program stored in the memory 10. Such a program may be distributed over a network or recorded on a recording medium. That is, such a program may be distributed, for example, as a program product.

In addition, as shown in FIG. 7B, for example, part or all of the network processing unit 120 may be configured with a processing circuit 12 such as a single circuit, a complex circuit, a programmed processor, a parallel programmed processor, an ASIC (Application Specific Integrated Circuit), or FPGA (Field Programmable Gate Array).

Thus, the network processing unit 120 can be configured with processing circuitry.

The LAN I/F unit 111 can be implemented by a communication interface such as a NIC (Network Interface Card) that can be connected to the LAN 104.

The WAN I/F unit 112 can be implemented by a communication interface such as a NIC that can be connected to the subscriber communication network 105.

Next, a method is described that implements the GUI settings shown in FIGS. 3 and 5 by processing packet filters inside Linux, which is often employed as an OS for in-home communication control devices.

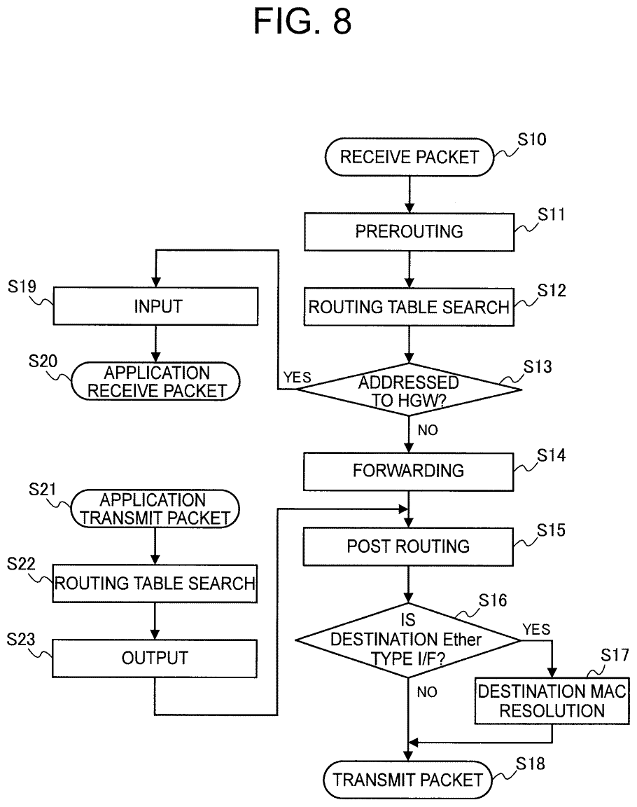

FIG. 8 is a flowchart schematically illustrating a packet filter operation inside Linux.

First, the LAN I/F unit 111 or the WAN I/F unit 112 receives a packet (S10). The received packet is sent to the S/W forwarding processing unit 140.

The pre routing execution unit 141a of the S/W forwarding processing unit 140 executes three predefined filtering processes based on ip6tables and provides the packet to the route resolution unit 142a (S11).

Next, the route resolution unit 142a executes a routing table search based on the destination of the packet (S12).

Then, the route resolution unit 142a determines whether the result of the routing table search in step S12 is addressed to its own HGW 110 (S13). If the destination of the packet is an external device that is not the HGW 110 (No in S13), the process proceeds to step S14, and if the destination of the packet is the HGW 110 (Yes in S13), the process proceeds to step S19.

In step S14, the packet is provided to the forwarding execution unit 141b, where two predetermined filtering processes are performed. The packet is then provided to the post routing execution unit 141c.

The post routing execution unit 141c performs the two predetermined filtering processes and then performs the output I/F transmission process (S15).

The post routing execution unit 141c determines whether the destination of the packet is an Ether type I/F in the output I/F transmission process (S16). If the destination of the packet is an Ether type I/F (Yes in S16), the process proceeds to step S17, and if the destination of the packet is not an Ether type I/F (No in S16), the process proceeds to step S18.

In step S17, the destination MAC resolution unit 142b performs destination MAC resolution for the destination IP address. The process then proceeds to step S18.

In step S18, the packet is provided to the LAN I/F unit 111 or WAN I/F unit 112, depending on the destination, and is transmitted from the LAN I/F unit 111 or WAN I/F unit 112.

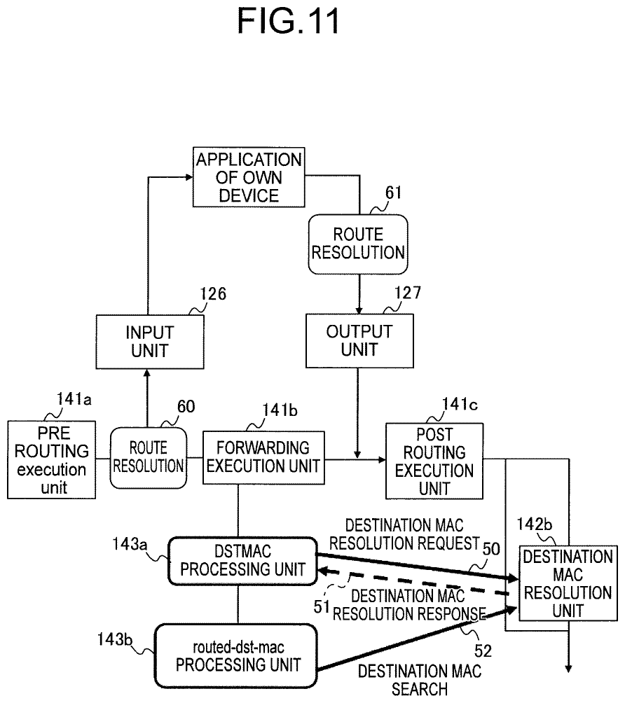

On the other hand, the packet whose destination is determined to be the HGW 110 in step S13 is subjected to two filtering processes in the INPUT unit 126 (see FIG. 11) in step S19.

It is then provided to the application of the HGW 110 (S20).

When the application of the HGW 110 transmits a packet (S21), the routing table search is performed on that packet by the route resolution unit 142a (S22).

Then, the OUTPUT unit 127 (see FIG. 11) performs two predefined filtering processes on that packet (S23). The packet is then sent to the post routing execution unit 141c, where steps S15 to S18 are performed in the same manner as above.

Next, the deployment of the LAN-side filtering settings shown in FIG. 3 is described.

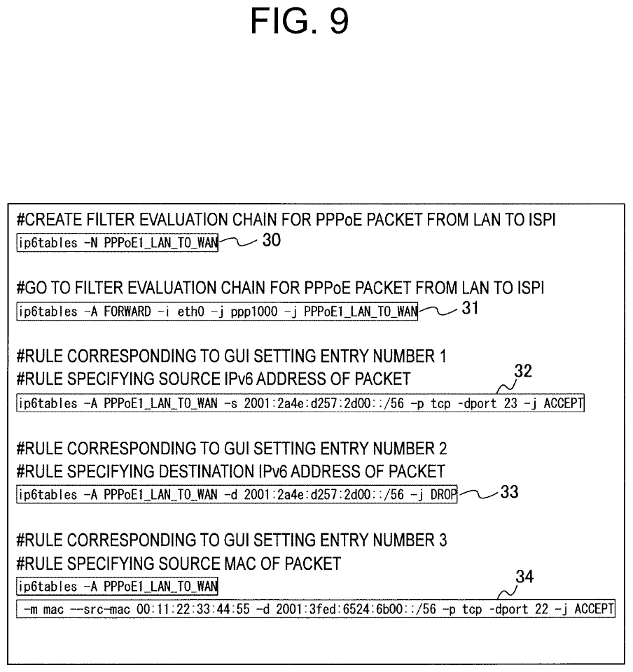

The LAN-side filtering settings shown in FIG. 3 are deployed in the packet filter operation inside Linux, as shown in FIG. 9.

First, since the LAN-side filtering settings is a filter for packets from the LAN to the PPPoE of ISP1, the corresponding chain 30, PPPoE1 LAN TO WAN, is created. Here, a chain is a block that sums up each evaluation rule.

Next, in this chain PPPoE1_LAN_TO_WAN, the I/F corresponding to the LAN (in this case, eth0) is specified as the input I/F, and the I/F corresponding to PPPoE (in this case, ppp1000) is specified as the output, thereby configuring a rule 31 which allows forwarded packets with the corresponding input and output I/Fs to pass.

Next, in this chain PPPoE1 LAN TO WAN, the evaluation rules corresponding to entry numbers 1 to 3 of the LAN-side filtering settings shown in FIG. 3 are described as rules 32 to 33.

Here, there is already a source MAC address specification “-m mac -src-mac” in the existing iptables determination conditions, so the filter settings using the source MAC address shown in entry number 3 in FIG. 3 is configured as rule 34 by specifying it without modification.

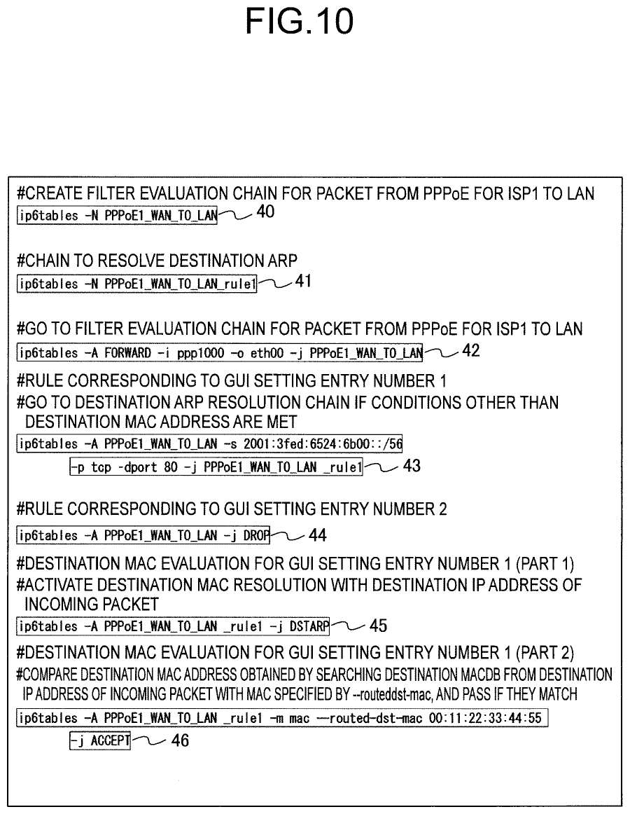

Next, the WAN-side filtering settings shown in FIG. 5 are deployed in the packet filter operation inside Linux, as shown in FIG. 10.

First, since the WAN-side filtering settings is a filter for packets from the PPPoE of ISP1 to the LAN, the corresponding chain 40, PPPoE1_WAN_TO_LAN, is created.

In addition, in Embodiment 1, if there is a setting that specifies a destination MAC filter in GUI filtering, PPPoE1_WAN_TO_LAN_rule1, which is a chain 41 corresponding to this, is created.

Then, in this chain PPPoE1_WAN_TO_LAN, the I/F corresponding to the LAN (in this case, eth0) is specified as the output I/F, and the I/F corresponding to PPPoE (in this case, ppp1000) is specified as the input I/F, thereby configuring a rule 42 which allows forwarded packets with the corresponding input and output I/Fs to pass.

Next, in this chain PPPoE1_WAN_TO_LAN, evaluation rules 43 and 44 corresponding to entry numbers 1 and 2 of the WAN-side filtering settings shown in FIG. 5 are described. Here, entry number 1, which specifies the destination MAC address in the filtering condition, is described as a rule 43.

The filtering settings other than the destination MAC address are deployed without modification to the filtering condition settings in the rule 43.

On the other hand, the filtering settings for the destination MAC address are configured to proceed to chains 45 and 46, which evaluate the chain PPPoE1_WAN_TO_LAN_rule1 for the destination MAC resolution determination.

The chains 45 and 46 represent two extended operations configured in iptables to implement filtering by destination MAC address in chain PPPoE1_WAN_TO_LAN_rule1 for destination MAC resolution determination.

The chain 45 is an evaluation rule that creates a new target DSTMAC that activates the process of resolving the destination MAC address from the destination IP address to allow packets to be subjected to destination MAC filtering to pass through the DSTMAC target.

The chain 46 is an evaluation rule that creates a new option-routed-dst-mac which determines the match with the destination MAC address resolved from the destination IP address to the extended match module mac for MAC address determination in iptables so that the destination MAC address filter condition can be specified therein.

Here, the existing extended match module mac and the option -mac-source to match with the source MAC address are described in the following document.

Document: iptables-extensions (retrieved on Dec. 16, 2021), URL: <https://www.linuxjm.osdn.jp/html/iptables/man8/iptables-extensions.8.html>

Next, the operation in the DSTMAC processing unit 143a, which is the extended operation in Embodiment 1, and the operation in the routed-dst-mac processing unit 143b, which is a new option of the extended match module for MAC address determination to determine the match with the destination MAC address, are explained with reference to FIG. 11.

FIG. 11 shows a simplified diagram of the IP packet filter process shown in FIG. 8 and the destination MAC resolution process.

In FIG. 11, the operation in the DSTMAC processing unit 143a and the operation in the routed-dst-mac processing unit 143b are assumed to be specified in the rules under the forward chain.

When the DSTMAC target operation by the DSTMAC processing unit 143a is specified as the target operation of the rule, the DSTMAC processing unit 143a issues a destination MAC address resolution request 50 from the destination IP address of the packet to the destination MAC resolution unit 142b with respect to the destination I/F of the packet obtained by a route resolution 60 performed by the route resolution unit 142a.

If the destination MAC resolution unit 142b already has the destination MAC address for the destination IP address and the destination MAC address resolved response is returned synchronously from the destination MAC resolution unit 142b, the DSTMAC processing unit 143a immediately returns from the DSTMAC target operation to perform the next rule evaluation.

On the other hand, when the destination MAC resolution unit 142b does not have the destination MAC address for the destination IP address and the destination MAC address resolution-executing response is returned from the destination MAC resolution unit 142b, the DSTMAC processing unit 143a queues the relevant packet, suspends the rule evaluation, and waits until it receives an asynchronous destination MAC address resolution response 51 from the destination MAC resolution unit 142b.

Then, upon receiving the asynchronous destination MAC address resolution response 51 from the destination MAC resolution unit 142b, the DSTMAC processing unit 143a returns from the DSTMAC target operation to evaluate the next rule.

Next, when an extended filtering operation by destination MAC address, which is to be performed by the routed-dst-mac processing unit 143b, is specified, the routed-dst-mac processing unit 143b requests a destination MAC address search 52 to the destination MAC resolution unit 142b from the destination IP address of the packet, with respect to the destination I/F of the packet obtained in the route resolution 61 performed by the route resolution unit 142a.

If the destination MAC resolution unit 142b has the destination MAC and responds with that destination MAC address, the routed-dst-mac processing unit 143b compares it with the destination MAC address filter condition passed as a parameter for further extended filtering operations.

If both match as a result of the comparison, the routed-dst-mac processing unit 143b determines that the extended filtering condition is satisfied.

On the other hand, if the destination MAC resolution unit 142b does not have the destination MAC address and responds with destination MAC address unknown, or if the responded destination MAC address does not match the destination MAC address filter condition passed as a parameter for the extended filtering operation, the routed-dst-mac processing unit 143b determines that the extended filtering condition is not satisfied.

With the DSTMAC processing unit 143a and the routed-dst-mac processing unit 143b performing this extended operation, the filter for entry number 1 shown in FIG. 5 can be deployed and implemented as in iptables rules 43, 45, and 46 in FIG. 10.

Next, the contents of the DSTMAC target process in FIG. 1 will be described.

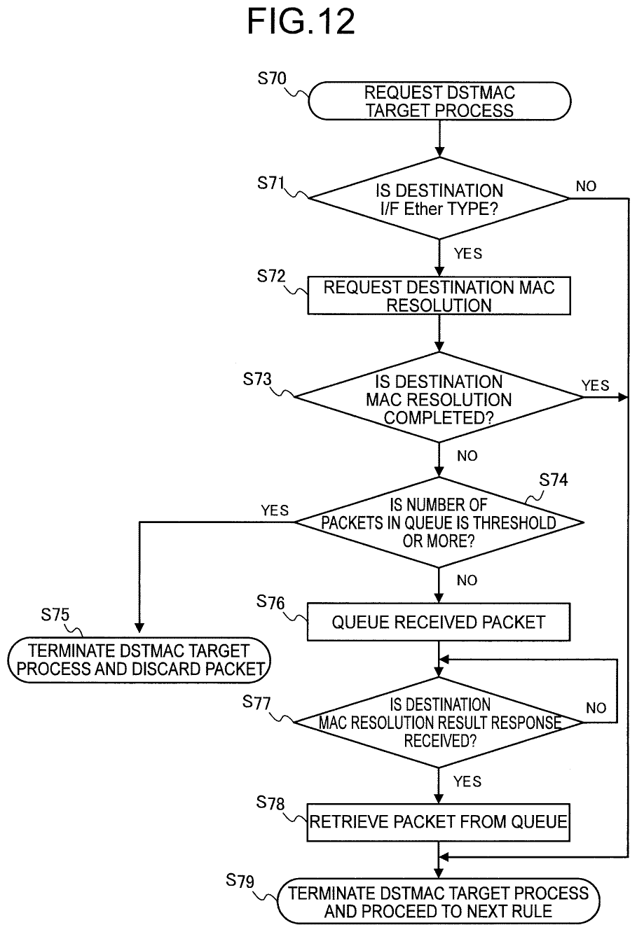

FIG. 12 is a flowchart showing the DSTMAC target process performed by the DSTMAC processing unit 143a.

In FIG. 12, the internal process of the DSTMAC target is requested from the iptables side at the time of evaluating the rule describing the DSTMAC target for the received packet.

When the DSTMAC target process is requested (S70), the DSTMAC processing unit 143a first examines the type of destination I/F of the packet to determine whether the type is Ether type or not (S71). If the type is not Ether type (No in S71), the destination MAC address resolution is unnecessary, so the process immediately proceeds to step S79 to terminate this DSTMAC target process and proceed to the next rule evaluation. On the other hand, if the type is Ether type (Yes in S71), the process proceeds to step S72.

In step S72, the DSTMAC processing unit 143a issues a destination MAC address resolution request to the destination MAC resolution unit 142b. The destination I/F for packets here is performed at the timing of route resolution 60 in FIG. 11 and only works for packets to be forwarded to other I/Fs. Therefore, the DSTMAC operation here can only be used in the chain after route resolution 60, e.g., forward or postrouting.

Next, the DSTMAC processing unit 143a determines whether or not a destination MAC resolved response has been returned from the destination MAC resolution unit 142b (S73). If a destination MAC resolved response is returned (Yes in S73), the destination MAC has been resolved, so processing immediately proceeds to step S79 to terminate this DSTMAC target process and proceed to the next rule evaluation.

On the other hand, if a destination MAC resolution-executing response is returned (No in S73), the process proceeds to step S74.

In step S74, the DSTMAC processing unit 143a counts the number of packets being queued in the DSTMAC processing unit 143a to determine whether the number of packets is equal to or more than a threshold value. If the number of packets is equal to or more than the threshold (Yes in S74), the process proceeds to step S75, and the DSTMAC processing unit 143a discards the packets as destination MAC resolution is not possible. On the other hand, if the number of packets is less than the threshold (No in S74), the process proceeds to step S76.

In step S76, the DSTMAC processing unit 143a queues that packet.

The DSTMAC processing unit 143a then determines whether a destination MAC resolution result response has been received from the destination MAC resolution unit 142b (S77). If a destination MAC resolution result response is received (Yes in S77), the process proceeds to step S78.

In step S78, the DSTMAC processing unit 143a retrieves the packet from the queue. The process then proceeds to step S79.

In step S79, the DSTMAC processing unit 143a terminates the DSTMAC target process and proceeds to the next rule evaluation.

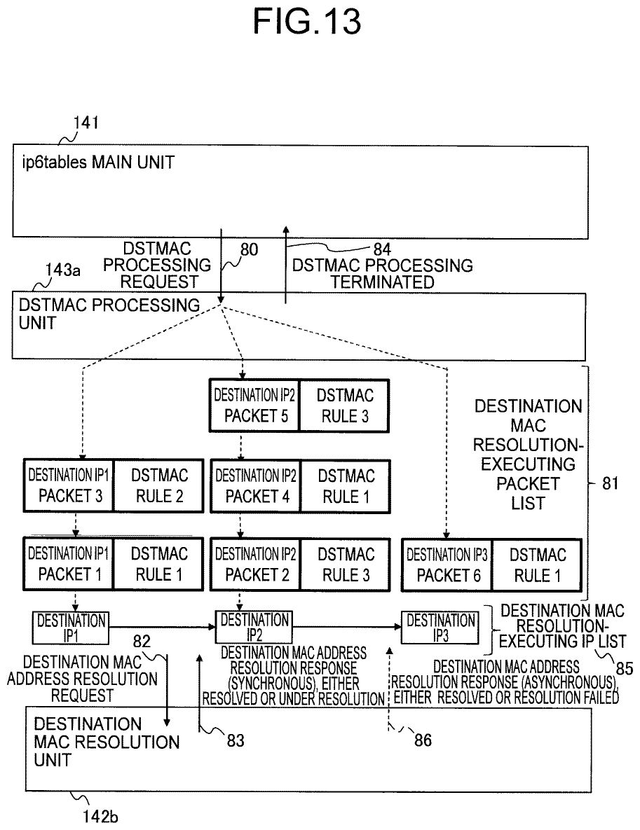

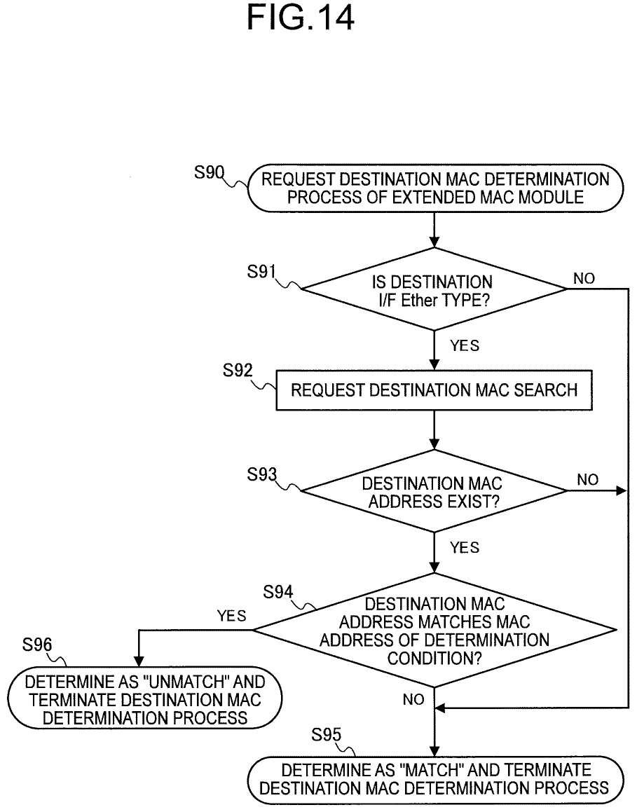

Next, an example implementation of the queuing process of the DSTMAC target shown in FIG. 12 will be explained with reference to FIG. 13.

First, when the ip6tables main unit 141 sends a DSTMAC processing request 80 to the DSTMAC processing unit 143a, the DSTMAC processing unit 143a checks whether the destination IP address of the packet exists in a destination MAC resolution-executing IP list 85.

If the destination IP address of the packet exists in the destination MAC resolution-executing IP list 85, the DSTMAC processing unit 143a pairs the packet for which the DSTMAC processing request 80 was made with the targeted DSTMAC rule and queues the packets in order of arrival for each destination IP.

If the destination IP address of the packet does not exist in the destination MAC resolution-executing IP list 85, the DSTMAC processing unit 143a calls the destination MAC resolution unit 142b by a destination MAC address resolution request 82.

The destination MAC resolution unit 142b responds with a synchronous destination MAC address resolution response 83, either “resolved” or “under resolution”.

If the destination MAC address resolution response is “resolved”, the DSTMAC processing unit 143a responds to the ip6tables main unit 141 as DSTMAC terminated 84 and proceeds to the next rule evaluation.

If the destination MAC address resolution response 83 is “under resolution”, the DSTMAC processing unit 143a creates a destination MAC resolution-executing IP list 85 for each destination IP to avoid doubly requesting destination MAC resolution.

Then, the DSTMAC processing unit 143a pairs a packet for which a DSTMAC processing request 80 has been made with the targeted DSTMAC rule to create a destination MAC resolution-executing packet list 81 for each destination IP address and queues them in order of packet arrival for each destination IP.

In this case, when the DSTMAC processing unit 143a receives an asynchronous destination MAC resolution result response 86 from the destination MAC resolution unit 142b, the DSTMAC processing unit 143a responds as DSTMAC process terminated 84 to all packets in the holding packet list corresponding to the destination IP of the destination MAC resolution result response 86 received from the destination MAC resolution-executing packet list 81 and, then proceeds to the next rule evaluation.

The process of simply queuing the packet under processing in the packet filter and then resuming it is already implemented in the QUEUE target, so the above process can be implemented by referring to the existing implementation.

Next, the processing performed by the routed-dst-mac processing unit 143b of Embodiment 1, which is an extended match module for MAC address determination, is described.

FIG. 14 is a flowchart illustrating a process performed by the routed-dst-mac processing unit 143b.

Here, the routed-dst-mac processing unit 143b asks the destination MAC resolution unit 142b whether or not the destination MAC address exists for the destination IP address of the packet, simply according to the rule using the extended match module for MAC address determination of FIG. 11.

First, when the destination MAC determination process of the extended MAC module is requested to the routed-dst-mac processing unit 143b (S90), the routed-dst-mac processing unit 143b checks the type of the destination I/F of the packet and determines whether or not the type is Ether type (S91). If the type is not Ether type (No in S91), the destination MAC cannot be resolved, so the process immediately proceeds to step S95, terminates the destination MAC determination process as “mismatch”, and proceeds to the next rule evaluation.

On the other hand, if the type is Ether type (Yes in S91), the routed-dst-mac processing unit 143b requests a destination MAC search to the destination MAC resolution unit 142b (S92). This corresponds to the process indicated by the reference number 52 in FIG. 11.

The routed-dst-mac processing unit 143b then determines whether or not the destination MAC address exists according to the response from the destination MAC resolution unit 142b (S93). If the destination MAC address does not exist (No in S93), the process immediately proceeds to step S95, terminates this destination MAC determination process as “mismatch”, and proceeds to the next rule evaluation.

On the other hand, if the destination MAC address exists (Yes in S93), the process proceeds to step S94.

In step S94, the routed-dst-mac processing unit 143b determines whether the destination MAC address matches the MAC address of the determination condition. If they do not match (No in S94), the process proceeds to step S95, and if they match (Yes in S94), the process proceeds to step S96.

In step S95, the routed-dst-mac processing unit 143b terminates its destination MAC determination process as “mismatch” and proceeds to the next rule evaluation.

On the other hand, in step S96, the routed-dst-mac processing unit 143b terminates the destination MAC determination process as “match” and proceeds to the next rule evaluation.

Thus, the filtering indicated by entry number 1 in FIG. 3, which includes the destination MAC address as a filtering condition, can be implemented to work with a desired operation by using the DSTMAC target operation described above and the destination MAC determination process of the extended MAC module, combined as shown in rules 43, 45, and 46 in FIG. 10.

As explained above, the HGW 110 of Embodiment 1, which is configured to resolve the destination MAC address for the destination IP address at any time during the packet filter evaluation after the routing table search and to evaluate subsequent packet filters based on the resolved destination MAC address, enables a connection from the terminal 101 on the LAN side in the direction from the LAN 104 to the WAN (subscriber communication network 105) to be specified by the source MAC address, or a connection from the subscriber communication network 105 which is the WAN, to the LAN 104 to be specified by the destination MAC address as well. This enables packet filtering specifications that are not affected by changes in the IP address assigned to the terminal 101 on the LAN 104 side.

In addition, since the destination MAC address resolution is specified as the target of packet filtering, packet filtering conditions other than the destination MAC address can be set as in rule 43, rule 45 5 can require destination MAC resolution only for packets that require destination MAC filtering, and rule 46 can be configured to evaluate conditions only for the destination MAC address. By configuring in this way, the destination MAC resolution process is not performed for packets that do not require destination MAC filtering, thereby reducing the processing load.

In the above explanation, the IPv6 address of the terminal 101 on the LAN 104 side changes according to the prefix assigned by the ISP network, but Embodiment 1 can be applied even when the terminal 101 on the LAN 104 side has an IPv4 address.

### Embodiment 2

In Embodiment 1, a new DSTARP target is created to request destination MAC address resolution and to hold packets during destination MAC resolution, but the configuration method for such operation is not limited to this.

Embodiment 2 shows a configuration example in which packet holding during destination MAC resolution is performed by an existing QUEUE target, and a request for destination MAC address resolution is performed by a DSTARP application that receives notification from the NFQUEUE target. The operation of the NFQUEUE target is described in the following document.

Document: iptables-extensions (retrieved on Dec. 16, 2021), URL: <https://Linuxjm.osdn.jp/html/iptables/man8/iptables-extensions.8.html>

As shown in FIG. 1, the communication system 200 including an HGW 210, which is the in-home communication device in Embodiment 2, includes the plurality of terminals 101, the subscriber access server 102, the first ISP system 103A, the second ISP system 103B, and the HGW 210.

The terminals 101, the subscriber access server 102, the first ISP system 103A, and the second ISP system 103B of the communication system 200 in Embodiment 2 are the same as the terminals 101, the subscriber access server 102, the first ISP system 103A, and the second ISP system 103B of the communication system 100 in Embodiment 1.

The HGW 210 includes the LAN I/F unit 111, the WAN I/F unit 112, and the network processing unit 220.

The LAN I/F unit 111 and the WAN I/F unit 112 of the HGW 210 of Embodiment 2 are the same as the LAN I/F unit 111 and the WAN I/F unit 112 of the HGW 110 of Embodiment 1.

The network processing unit 220 controls processing in the HGW 210. For example, the network processing unit 220 controls the relay processing that outputs packets from the subscriber communication network 105 to the LAN 104 and packets from the LAN 104 to the subscriber communication network 105. Here, it is assumed that the network processing unit 220 supports IPv6.

The network processing unit 220 includes the PPPoEv6 client function unit 121, the DHCPv6 client function unit 122, the DHCPv6 server function unit 123, the IPv6 router notification server function unit 124, and an IPv6 packet filter function unit 225.

The PPPoEv6 client function unit 121, the DHCPv6 client function unit 122, the DHCPv6 server function unit 123, and the IPv6 router notification server function unit 124 of the network processing unit 220 in Embodiment 2 are the same as the PPPoEv6 client function unit 121, the DHCPv6 client function unit 122, the DHCPv6 server function unit 123, and the IPv6 router notification server function unit 124 of the network processing unit 120 in Embodiment 1.

The IPv6 packet filter function unit 225 performs filtering of packets from the LAN 104 side received by the LAN I/F unit 111 and packets from the subscriber communication network 105 side received by the WAN I/F unit 112.

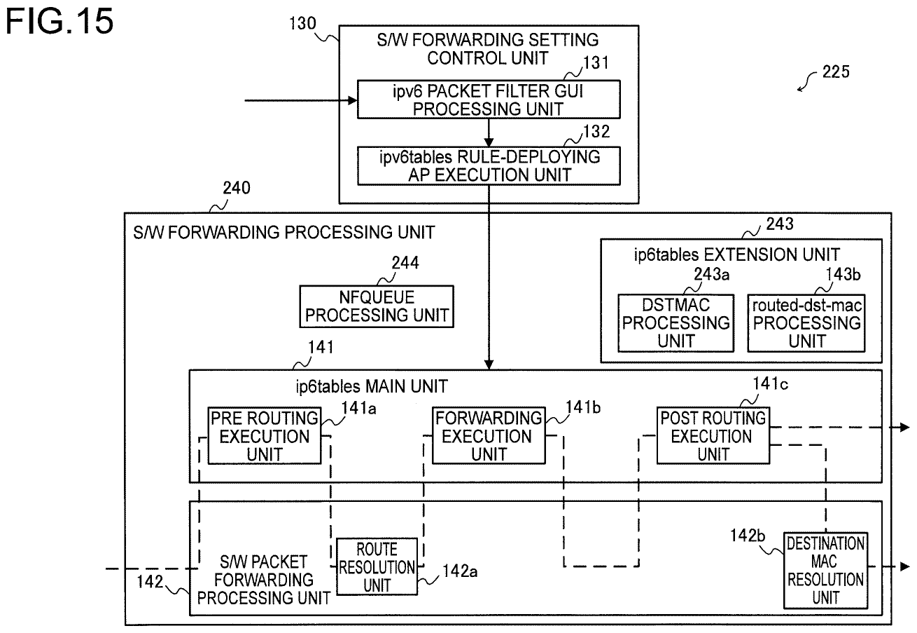

FIG. 15 is a block diagram schematically illustrating the IPv6 packet filter function unit 225 of Embodiment 2.

The IPv6 packet filter function unit 225 includes the S/W forwarding setting control unit 130 and an S/W forwarding processing unit 240.

The S/W forwarding setting control unit 130 of the IPv6 packet filter function unit 225 in Embodiment 2 is the same as the S/W forwarding setting control unit 130 of the IPv6 packet filter function unit 125 in Embodiment 1.

The S/W forwarding processing unit 240 performs filtering of LAN-side packets received by the LAN I/F unit 111 or WAN-side packets received by the WAN I/F unit 112 and forwards those packets.

The S/W forwarding processing unit 240 includes the ip6tables main unit 141, the S/W packet forwarding processing unit 142, an ip6tables extension unit 243, and an NFQUEUE processing unit 244.

The ip6tables main unit 141 and the S/W packet forwarding processing unit 142 of the S/W forwarding processing unit 240 in Embodiment 2 are the same as the ip6tables main unit 141 and the S/W packet forwarding processing unit 142 of the S/W forwarding processing unit 140 in Embodiment 1.

The ip6tables extension unit 243 performs filtering by a destination MAC address with the destination MAC resolution determination chain PPOE1_WAN_TO_LAN rule1, which is an extension of the process in the ip6tables main unit 141, in response to instructions from the ip6tables main unit 141.

The ip6tables extension unit 243 includes a DSTMAC processing unit 243a and the routed-dst-mac processing unit 143b.

The routed-dst-mac processing unit 143b of the ip6tables extension unit 243 in Embodiment 2 is the same as the routed-dst-mac processing unit 143b of the ip6tables extension unit 143 in Embodiment 1.

The DSTMAC processing unit 243a is activated to perform the process of resolving the destination MAC address from the destination IP address, and provides received packets to the routed-dst-mac processing unit 143b according to the evaluation rules configured to allow packets to be subjected to destination MAC filtering to pass through the DSTMAC target.

In Embodiment 2, the DSTMAC processing unit 243a does not hold and retransmit received packets but allows the NFQUEUE processing unit 244 to perform these processes.

The NFQUEUE processing unit 244 performs the hold and retransmission of received packets. For example, the NFQUEUE processing unit 244 temporarily stores the packets before address resolution is performed in a memory (not shown) that functions as a temporary storage unit. This memory may be the memory 10 shown in FIG. 7A, or it may be provided separately from the memory 10.

Thus, in Embodiment 2, when a packet is temporarily stored in the temporary storage unit via the NFQUEUE processing unit 244, the ip6tables extension unit 243 requests the destination MAC resolution unit 142b to resolve the address of the packet, and after the address resolution of the packet is performed, performs the MAC filtering by using the MAC address resolved by address resolution.

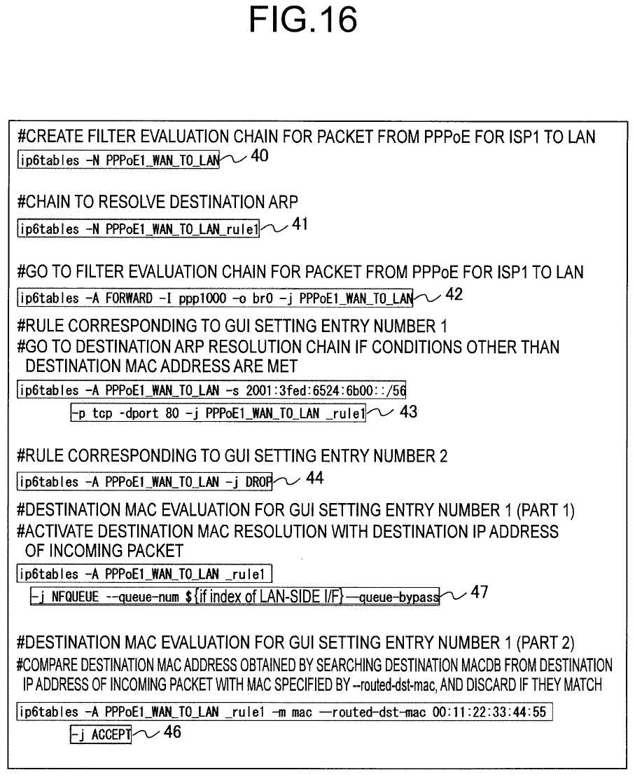

In Embodiment 2, the WAN-side filtering settings shown in FIG. 5 are deployed in the Linux internal packet filter operation as shown in FIG. 16.

The deployment shown in FIG. 16 is almost the same as the deployment shown in FIG. 10, except that rule 45 in the deployment shown in FIG. 10 is changed to rule 47.

Rule 47 deploys the behavior for activating destination MAC resolution in NFQUEUE, which is an existing extension target of iptables, and further specifies in parameter-queue-num the ifindex, which is the I/F number of the LAN-side I/F.

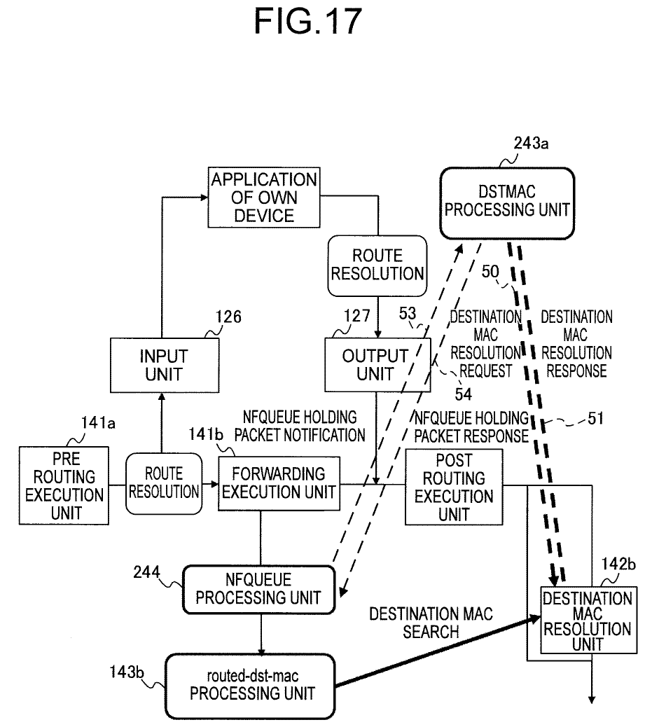

Next, the operation of destination MAC address resolution will be explained with reference to FIG. 17, where NFQUEUE is used to hold packets during destination MAC resolution in Embodiment 2.

FIG. 17 is a simplified diagram illustrating an IP packet filter process and a destination MAC resolution process.

In Embodiment 2, the NFQUEUE processing unit 244 operates according to the specification of rule 47, which requires destination MAC address resolution, to execute the NFQUEUE target instead of the DSTMAC target.

Specifically, the NFQUEUE processing unit 244 holds the packet and sends NFQUEUE holding packet notification 53 to the DSTMAC processing unit 243a, which runs the DSTMAC application on user space.

The DSTMAC processing unit 243a analyzes the destination IP address of the notified holding packet and sends a destination MAC address resolution request 50 to the destination MAC resolution unit 142b if the destination MAC address for the destination IP address is not under resolution.

Upon completion of the destination MAC address resolution, the destination MAC resolution unit 142b responds with a destination MAC address resolution response 51 to the DSTMAC processing unit 243a. The DSTMAC processing unit 243a then sends NFQUEUE holding packet response 54 for all NFQUEUE holding packet notifications 53 for the corresponding destination IP address to the NFQUEUE processing unit 244.

Upon receiving the NFQUEUE holding packet response 54, the NFQUEUE processing unit 244 discards the packet or resumes the next rule evaluation based on the notification from the DSTMAC processing unit 243a.

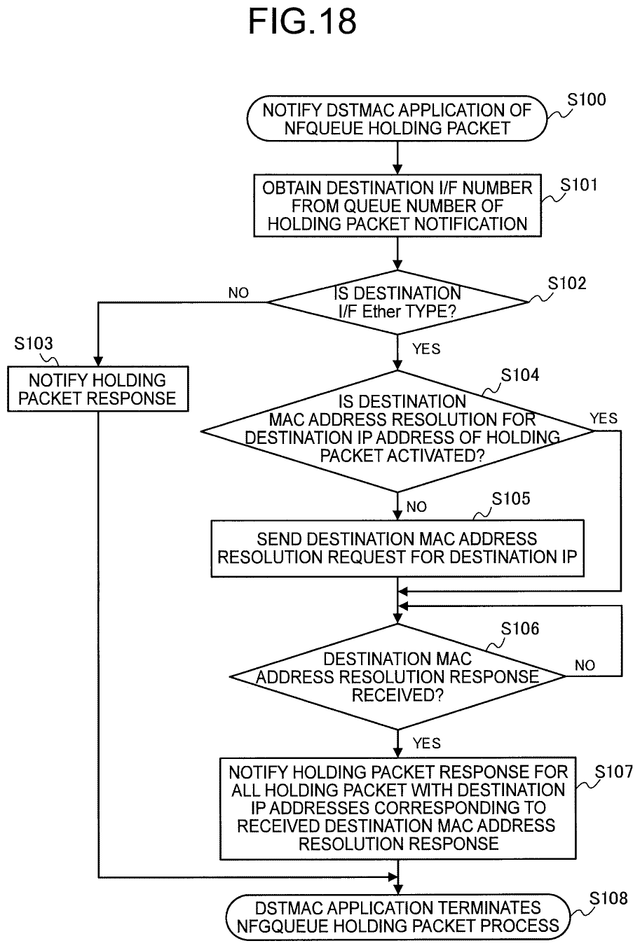

FIG. 18 is a flowchart illustrating an operation of the DSTMAC processing unit 243a when a packet under destination MAC resolution is held by NFQUEUE in Embodiment 2.

When the DSTMAC processing unit 243a is notified of a holding packet from the NFQUEUE processing unit 244 (S100), the DSTMAC processing unit 243a first obtains the I/F number of the destination I/F from the holding packet queue number (S101).

Then, the DSTMAC processing unit 243a checks the type of that destination I/F and determines whether the type of the destination I/F is Ether type or not (S102). If the type of the destination I/F is not Ether type (No in S102), the process proceeds to step S103, and if the type of the destination I/F is Ether type (Yes in S102), the process proceeds to step S104.

In step S103, the DSTMAC processing unit 243a notifies the NFQUEUE processing unit 244 of the holding packet response to proceed to the next rule, since the destination MAC address resolution is unnecessary. The process then proceeds to step S108 to terminate the NFGQUEUE holding packet process.

On the other hand, if the destination I/F type is Ether type (Yes in S102), in step S104, the DSTMAC processing unit 243a determines whether the destination MAC address resolution for the destination IP address of the holding packet is activated. If the destination MAC address resolution is not activated (No in S104), the process proceeds to step S105, and if the destination MAC address resolution is activated (Yes in S104), the process proceeds to step S106.

In step S105, the DSTMAC processing unit 243a sends a destination MAC address resolution request to the destination MAC resolution unit 142b. The process then proceeds to step S106.

In step S106, the DSTMAC processing 243a determines whether a destination MAC address resolution response has been received from the destination MAC resolution unit 142c. If the destination MAC address resolution response has been received (Yes in S106), the process proceeds to step S107.

In step S107, the DSTMAC processing unit 243a notifies the NFQUEUE processing unit 244 of the holding packet response to proceed to the next rule for all holding packet notifications with destination IP addresses corresponding to the received destination MAC address resolution response. The process then proceeds to step S108 to terminate the NFQUEUE holding packet process.

As explained above, in the HGW 210 of Embodiment 2, an existing NFQUEUE target is used instead of the DSTMAC target introduced in Embodiment 1, and the destination MAC resolution is performed by the DSTMAC processing unit 243a that receives packet-holding notifications from the NFQUEUE target.

Therefore, the DSTMAC processing unit 243a does not need to have its own packet hold or retransmission logic, which simplifies the process.

An example of an application that uses the NFQUEUE target is described in the following document.

Document: sample-helloworld.c (retrieved on Dec. 16, 2021), URL: <https://github.com/irontec/netfilter-nfqueue-samples/blob/master/sample-helloworld.c>

As shown in this example, the DSTMAC processing unit 243a is a process that runs in user space, which has the advantage of being easier to create than DSTMAC targets that are created in kernel space.

### Embodiment 3

While Embodiment 1 or 2 showed a control method for the HGWs 110 and 210 having a packet filter that allows specification of the MAC address of the LAN-side terminal, Embodiment 3 enables high-speed IP packet forwarding by H/W (HardWare).

As shown in FIG. 1, the communication system 300 including an HGW 310, which is the in-home communication device for Embodiment 3, includes the plurality of terminals 101, the subscriber access server 102, the first ISP system 103A, the second ISP system 103B, and the HGW 310.

The terminals 101, the subscriber access server 102, the first ISP system 103A, and the second ISP system 103B of the communication system 300 in Embodiment 3 are the same as the terminals 101, the subscriber access server 102, the first ISP system 103A, and the second ISP system 103B of the communication system 100 in Embodiment 1.

The HGW 310 includes a LAN I/F unit 111, a WAN I/F unit 112, and a network processing unit 320.

The LAN I/F unit 111 and the WAN I/F unit 112 of the HGW 310 of Embodiment 3 are the same as the LAN I/F unit 111 and the WAN I/F unit 112 of the HGW 110 of Embodiment 1.

The network processing unit 320 controls processing in the HGW 310. For example, the network processing unit 320 controls the relay processing to output packets from the subscriber communication network 105 to the LAN 104 and packets from the LAN 104 to the subscriber communication network 105. Here, it is assumed that the network processing unit 320 supports IPv6.

The network processing unit 320 includes the PPPoEv6 client function unit 121, the DHCPv6 client function unit 122, the DHCPv6 server function unit 123, the IPv6 router notification server function unit 124, and an IPv6 packet filter function unit 325.

The PPPoEv6 client function unit 121, the DHCPv6 client function unit 122, the DHCPv6 server function unit 123, and the IPv6 router notification server function unit 124 of the network processing unit 320 in Embodiment 3 are the same as the PPPoEv6 client function unit 121, the DHCPv6 client function unit 122, the DHCPv6 server function unit 123, and the IPv6 router notification server function unit 124 of the network processing unit 120 in Embodiment 1.

The IPv6 packet filter function unit 325 performs filtering of packets from the LAN 104 side received by the LAN I/F unit 111 and packets from the subscriber communication network 105 side received by the WAN I/F unit 112.

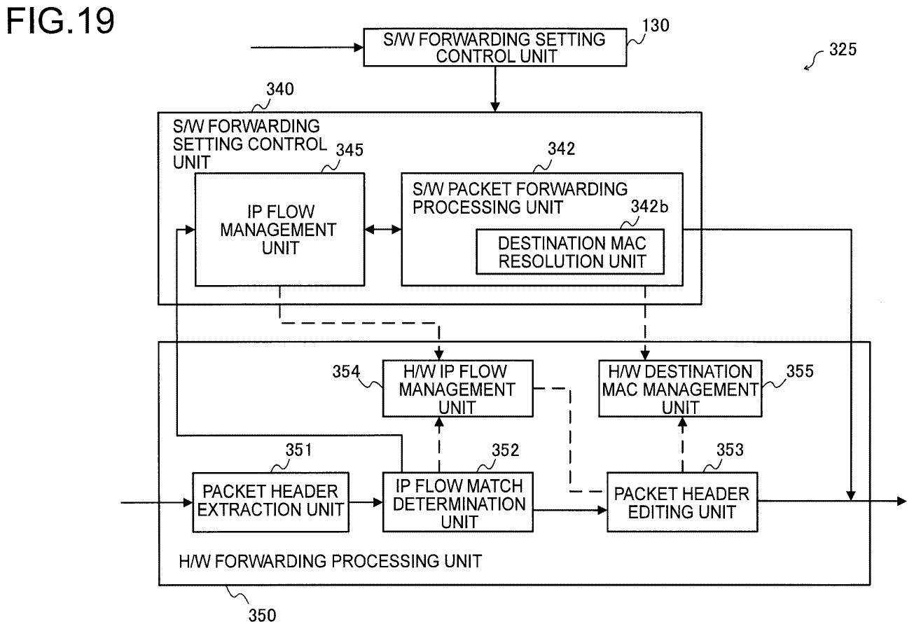

FIG. 19 is a block diagram schematically illustrating a configuration of the IPv6 packet filter function unit 325 in Embodiment 3.

The IPv6 packet filter function unit 325 includes the S/W forwarding setting control unit 130, an S/W forwarding processing unit 340 executed by S/W, and an H/W forwarding processing unit 350 executed by H/W.

The S/W forwarding processing unit 340 includes the S/W packet forwarding processing unit 342, which performs filter processing combining IP addresses and MAC addresses as described in Embodiment 1 or 2, and an IP flow management unit 345.

The S/W packet forwarding processing unit 342 includes a destination MAC resolution unit 342b.

Note that only the packet filtering operation and basic operations for IP packet forwarding in Embodiment 3 are described here, since the internal configuration of the H/W forwarding processing unit 350 varies in many ways.

The H/W forwarding processing unit 350 includes a packet header extraction unit 351, an IP flow match determination unit 352, a packet header editing unit 353, an H/W IP flow management unit 354, and an H/W destination MAC management unit 355.

The packet header extraction unit 351 examines the IP header of IP packets received by the reception I/F, LAN I/F unit 111 or WAN I/F unit 112, and extracts {source IP address, destination IP address, protocol, source port number, destination port number} in the IP header. The information combining the five values in {} is the basic configuration information to identify which connection the packet belongs to and is called session information or IP flow information.

This session information or IP flow information is used to provide consistent processing for IP packets belonging to the same session. For example, when the source address or the source port number is converted by the NAT (Network Address Translation) process or the NAPT (Network Address Port Translation) process, all IP packets belonging to the same session must be converted with the same source address or source port number.

To achieve this, the source address or source port number for NAPT conversion is specified in the first packet, and all subsequent packets with the same session information or IP flow information are converted to have the same source address or source port number as the first packet. This session information or IP flow information corresponds to the management information called conntrack information in the network stack in Linux, e.g., and is managed by the IP flow management unit 345. Specifically, the IP flow management unit 345 stores the session information or IP flow information in a memory (not shown) that functions as a storage unit. This memory may be the memory 10 shown in FIG. 7A, or it may be provided separately from the memory 10.

The IP flow match determination unit 352 determines whether the flow information extracted by the packet header extraction unit 351 matches the entry registered in the H/W IP flow management unit 354 in the H/W forwarding processing unit 350.

Since IP flow information is not registered in the H/W IP flow management unit 354 for the first packet of the session, the IP flow match determination unit 352 sends that packet to the S/W forwarding processing unit 340 as there is no flow information for H/W forwarding processing.

Upon receiving that packet, the S/W forwarding processing unit 340 performs destination route resolution and filtering processing in the S/W packet forwarding processing unit 342. The process in the S/W packet forwarding processing unit 362 is as explained with reference to FIG. 11. In other words, the process in the S/W packet forwarding processing unit 362 is a combination of packet filtering and destination route resolution, as described in Embodiment 1.

In the packet filtering process, the S/W packet forwarding processing unit 342 can perform filtering by the MAC address of the LAN-side terminal as described in Embodiment 1.

Here, if the S/W packet forwarding processing unit 342 determines that the first packet should be discarded in the filtering process, the IP flow information of the packet is not registered in the IP flow management unit 345 in the S/W forwarding processing unit 340, nor is its entry registered in the H/W IP flow management unit 354. Therefore, subsequent packets are sent to the S/W forwarding processing unit 340 in the same manner, and the S/W forwarding processing unit 340 determines them to be discarded in the same manner, and subsequent packets belonging to that IP flow are not forwarded.

On the other hand, if the S/W packet forwarding processing unit 342 determines that the first packet should be passed in the filtering process, the IP flow information of that packet is registered in the IP flow management unit 345 in the S/W forwarding processing unit 340. At this time, the IP flow management unit 345 also causes the H/W IP flow management unit 354 to register that IP flow information.

The destination MAC resolution unit 342b of the S/W packet forwarding processing unit 342 then performs the destination MAC resolution process on that first packet and returns that packet to the H/W forwarding processing unit 350.

The H/W forwarding processing unit 350 then transmits that packet from the LAN I/F unit 111 or WAN I/F unit 112, which is the transmission I/F on the opposite side.

Here, the destination MAC resolution unit 342b of the S/W packet forwarding processing unit 342 registers the MAC address resolved for the IP address so that it is always synchronized with the H/W destination MAC management unit 355 of the H/W forwarding processing unit 350.

Next, when a subsequent packet is received, the packet header extraction unit 351 examines the header of the subsequent packet in the same way as the first packet and extracts {source IP address, destination IP address, protocol, source port number, destination port number} in the IP header.

Next, the IP flow match determination unit 352 determines whether the extracted flow information matches the registered entry in the H/W IP flow management unit 354 in the H/W forwarding processing unit 350. Here, since the IP flow information of the subsequent packets of the session is registered in the H/W IP flow management unit 354, the IP flow match determination unit 352 determines as “flow information matching”.

Packets determined as “flow information matching” here are sent to the subsequent packet header editing unit 353, except for some packets that require processing in the S/W forwarding processing unit 340 or some exceptional packets that cannot be processed in the H/W forwarding processing unit 350. Some packets that require processing in the S/W forwarding processing unit 340 are, e.g., control packets with the SYN, FIN, or RST flags of the TCP (Transmission Control Protocol).

The packet header editing unit 353 performs the necessary packet header editing processing based on the IP flow editing information possessed by the H/W IP flow management unit 354 and the MAC address possessed by the H/W destination MAC management unit 355. For example, the packet header editing unit 353 updates the address or port number of the packet for NAT processing, updates the source MAC based on the transmission I/F, or updates the destination MAC address for the next hop after routing.

Subsequent packets that have completed the packet header editing process are finally sent by the LAN I/F unit 111 or the WAN I/F unit 112, which is the opposite transmission I/F and are processed only by the H/W forwarding processing unit 350, in other words, without going through the S/W forwarding processing unit 340.

The H/W forwarding processing unit 350 described above can be implemented, e.g., by the processing circuit 12 shown in FIG. 7B.

Thus, in the HGW 310 of Embodiment 3, a determination based on the MAC address of the LAN-side terminal is made for the first packet, and if the first packet is determined to be passed, the subsequent packets are forwarded and processed by H/W by using the IP flow information. Therefore, even a general H/W forwarding processing unit (NetworkProcessor) that does not have a filtering function using MAC addresses can achieve filtering operation by using the MAC address of the LAN-side terminal and high-speed IP packet forwarding operation by using H/W.

In other words, in Embodiment 3, the HGW 310 is further includes the H/W forwarding processing unit 350 that functions as a hardware forwarding unit that routes packets using hardware, and the ip6tables extension unit 143 performs MAC filtering on the first packet of the session; if the MAC filtering passes the first packet of the session, the H/W forwarding processing unit 350 can be made to perform routing on subsequent packets that are subsequent packets of the same session as the first packet, and not to perform MAC filtering on the subsequent packets.

The configuration of Embodiment 3 is based on the configuration of Embodiment 1, but the configuration of Embodiment 3 may be based on the configuration of Embodiment 2.

### DESCRIPTION OF REFERENCE CHARACTERS

100, 200, 300 communication system, 101 terminal, 102 subscriber access server, 103A first ISP system, 103B second ISP system, 110 HGW, 111 LAN I/F unit, 112 WAN I/F unit, 120, 220, 320 network processing unit, 121 PPPoEv6 client function unit, 122 DHCPv6 client function unit, 123 DHCPv6 server function unit, 124 IPv6 router notification server function unit, 125, 225, 325 IPv6 packet filter function unit, 130 S/W forwarding setting control unit, 131 ipv6 packet filter GUI processing unit, 132 ipv6tables rule-deploying AP execution unit, 140, 240, 340 S/W forwarding processing unit, 141 ip6tables main unit, 141a pre routing execution unit, 141b forwarding execution unit, 141c post routing execution unit, 142, 342 S/W packet forwarding processing unit, 142a route resolution unit, 142b, 342b destination MAC resolution unit, 143, 243 ip6tables extension unit, 143a, 243a DSTMAC processing unit, 143b routed-dst-mac processing unit, 244 NFQUEUE processing unit, 345 IP flow management unit, 350 H/W forwarding processing unit, 351 packet header extraction unit, 352 IP flow match determination unit, 353 packet header editing unit, 354 H/W IP flow management unit, 355 H/W destination MAC management unit

1. An in-home communication device, comprising:
a reception interface to receive a packet;
processing circuitry to perform address resolution for the packet, to route the packet, and to perform MAC filtering according to a rule of an IP (Internet Protocol) packet filter, the MAC filtering being a filtering of the destination MAC (Media Access Control) address of the packet after the routing.

2. The in-home communication device according to claim 1, wherein
the rule is to perform the address resolution of the packet after the routing and to perform the MAC filtering by using the destination MAC address resolved by the address resolution, and
processing circuitry performs the address resolution in accordance with the rule and-to perform the MAC filtering by using the resolved destination MAC address.

3. The in-home communication device according to claim 2, further comprising:
a memory to temporarily store the packet before the address resolution is performed, wherein
when the packet is temporarily stored in the memory, the processing circuitry performs the address resolution of the packet, and after the address resolution of the packet is performed, performs the MAC filtering by using the MAC address resolved by the address resolution.

4. The in-home communication device according to claim 1, wherein
the reception interface receives the packets from a WAN (Wide Area Network),
the processing circuitry routes the packet to a LAN (Local Area Network), and
performs the MAC filtering on the destination MAC address specifying the MAC address of a terminal connected to the LAN, without using the IP address of the terminal.

5. The in-home communication device according to claim 4, wherein
the processing circuitry distributes the IP address to the terminal and performs IP filtering, the IP filtering being a filtering using the IP address.

6. The in-home communication device according to claim 5, wherein
the processing circuitry distributes to the terminal the IP address included in an IPv6 address range according to an IPv6 (Internet Protocol version 6) prefix obtained from the WAN.

7. The in-home communication device according to claim 4, wherein
the processing circuitry generates the IP address by notifying the terminal of an IPv6 address range according to an IPv6 (Internet Protocol version 6) prefix obtained from the WAN and executes IP filtering, the IP filtering being a filtering using the IP address.

8. The in-home communication device according to claim 1, wherein
the processing circuitry performs routing of the packet by using hardware, performs MAC filtering on a first packet of the session as the packet, and if the first packet is passed by the MAC filtering, performs routing but does not perform the MAC filtering for the subsequent packets belonging to the same session with the first packet.

9. A filtering method, comprising:
receiving a packet;
routing the packet;
resolving the address of the packet after the routing according to a rule of an IP (Internet Protocol) packet filter; and
performing MAC filtering, which is a filtering of the destination MAC (Media Access Control) address of the packet resolved by the address resolution.

10. The in-home communication device according to claim 2, wherein
the reception interface receives the packets from a WAN (Wide Area Network),
the processing circuitry routes the packet to a LAN (Local Area Network), and performs the MAC filtering on the destination MAC address specifying the MAC address of a terminal connected to the LAN, without using the IP address of the terminal.

11. The in-home communication device according to claim 3, wherein
the reception interface receives the packets from a WAN (Wide Area Network),
the processing circuitry routes the packet to a LAN (Local Area Network), and performs the MAC filtering on the destination MAC address specifying the MAC address of a terminal connected to the LAN, without using the IP address of the terminal.

12. The in-home communication device according to claim 2, wherein
the processing circuitry performs routing of the packet by using hardware, performs MAC filtering on a first packet of the session as the packet, and if the first packet is passed by the MAC filtering, performs routing but does not perform the MAC filtering for the subsequent packets belonging to the same session with the first packet.

13. The in-home communication device according to claim 3, wherein
the processing circuitry performs routing of the packet by using hardware, performs MAC filtering on a first packet of the session as the packet, and if the first packet is passed by the MAC filtering, performs routing but does not perform the MAC filtering for the subsequent packets belonging to the same session with the first packet.

14. The in-home communication device according to claim 4, wherein
the processing circuitry performs routing of the packet by using hardware, performs MAC filtering on a first packet of the session as the packet, and if the first packet is passed by the MAC filtering, performs routing but does not perform the MAC filtering for the subsequent packets belonging to the same session with the first packet.

15. The in-home communication device according to claim 5, wherein
the processing circuitry performs routing of the packet by using hardware, performs MAC filtering on a first packet of the session as the packet, and if the first packet is passed by the MAC filtering, performs routing but does not perform the MAC filtering for the subsequent packets belonging to the same session with the first packet.

16. The in-home communication device according to claim 6, wherein
the processing circuitry performs routing of the packet by using hardware, performs MAC filtering on a first packet of the session as the packet, and if the first packet is passed by the MAC filtering, performs routing but does not perform the MAC filtering for the subsequent packets belonging to the same session with the first packet.

17. The in-home communication device according to claim 7, wherein
the processing circuitry performs routing of the packet by using hardware, performs MAC filtering on a first packet of the session as the packet, and if the first packet is passed by the MAC filtering, performs routing but does not perform the MAC filtering for the subsequent packets belonging to the same session with the first packet.

18. The in-home communication device according to claim 10, wherein
the processing circuitry performs routing of the packet by using hardware, performs MAC filtering on a first packet of the session as the packet, and if the first packet is passed by the MAC filtering, performs routing but does not perform the MAC filtering for the subsequent packets belonging to the same session with the first packet.

19. The in-home communication device according to claim 11, wherein
the processing circuitry performs routing of the packet by using hardware, performs MAC filtering on a first packet of the session as the packet, and if the first packet is passed by the MAC filtering, performs routing but does not perform the MAC filtering for the subsequent packets belonging to the same session with the first packet.
